(19) United States
(12) Patent Application Publication
(10) Pub. No.: US 2025/0328864 A1
(43) Pub. Date: Oct. 23, 2025

(54) Utilizing Local Workgroups in a Stretched Environment

(71) Applicant: Dell Products L.P., Round Rock, TX (US)

(72) Inventors: Boris Shpilyuck, Ashdod (IL); Yair Yotam, Lehavim (IL); Igor Dubrovsky, Beer-Sheva (IL); Nisan Haimov, Beer-Sheva (IL)

(21) Appl. No.: 18/643,887

(22) Filed: Apr. 23, 2024

(51) Int. Cl. G06Q 10/10

(52) U.S. Cl. CPC G06Q 10/103

(57) ABSTRACT

A system can maintain a microservices architecture on the system, wherein the microservices architecture comprises a group of microservices. The system can maintain information about a work group that identifies a group of respective remote microservices on respective remote computers. The system can receive a request to invoke the group of microservices, wherein the request is associated with a request initiator. The system can determine that the request initiator is a member of the work group. The system can process a first part of the request using the group of microservices. The system can process a second part of the request using the group of respective remote microservices.

### BACKGROUND

Microservices can generally be a variant of a service-oriented architecture (SOA) computer architectural style that structures an application as a collection of loosely coupled services. Microservices can be deployed as part of a software as a service (SaaS) model, where a system of microservices is centrally hosted, and is accessed by a thin client (e.g., a web browser).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can maintain a microservices architecture on the system, wherein the microservices architecture comprises a group of microservices. The system can maintain a microservices architecture on the system, wherein the microservices architecture comprises a group of microservices. The system can maintain information about a work group that identifies a group of respective remote microservices on respective remote computers. The system can receive a request to invoke the group of microservices, wherein the request is associated with a request initiator. The system can determine that the request initiator is a member of the work group. The system can process a first part of the request using the group of microservices. The system can process a second part of the request using the group of respective remote microservices.

An example method can comprise receiving, by a system comprising at least one processor, a request to invoke microservices, wherein the request is associated with a request initiator. The method can further comprise determining, by the system, that the request initiator is a member of a work group that identifies respective remote microservices on respective remote computers, wherein the respective remote microservices corresponds to respective microservices of the microservices. The method can further comprise processing, by the system, a first part of the request using the microservices on the system. The method can further comprise processing, by the system, a second part of the request using the respective remote microservices.

An example non-transitory computer-readable medium can comprise instructions that, in response to execution, cause a system comprising a processor to perform operations. These operations can comprise receiving a request to invoke microservices, wherein the request is associated with a request initiator. The operations can further comprise determining that the request initiator is a member of a work group that identifies respective remote microservices on respective remote computers. The operations can further comprise processing a first part of the request using the microservices. The operations can further comprise processing a second part of the request using the respective remote microservices.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate utilizing local workgroups in a stretched environment, in accordance with an embodiment of this disclosure;

FIG. 2 illustrates another example system architecture that can facilitate utilizing local workgroups in a stretched environment, in accordance with an embodiment of this disclosure;

FIG. 3 illustrates another example system architecture that can facilitate utilizing local workgroups in a stretched environment, in accordance with an embodiment of this disclosure;

FIG. 4 illustrates another example system architecture that can facilitate utilizing local workgroups in a stretched environment, in accordance with an embodiment of this disclosure;

FIG. 5 illustrates another example system architecture that can facilitate utilizing local workgroups in a stretched environment, in accordance with an embodiment of this disclosure;

FIG. 6 illustrates an example process flow that can facilitate utilizing local workgroups in a stretched environment, in accordance with an embodiment of this disclosure;

FIG. 7 illustrates another example process flow that can facilitate utilizing local workgroups in a stretched environment, in accordance with an embodiment of this disclosure;

FIG. 8 illustrates another example process flow that can facilitate utilizing local workgroups in a stretched environment, in accordance with an embodiment of this disclosure;

FIG. 9 illustrates another example process flow that can facilitate utilizing local workgroups in a stretched environment, in accordance with an embodiment of this disclosure;

FIG. 10 illustrates another example process flow that can facilitate utilizing local workgroups in a stretched environment, in accordance with an embodiment of this disclosure;

FIG. 11 illustrates another example process flow that can facilitate utilizing local workgroups in a stretched environment, in accordance with an embodiment of this disclosure;

FIG. 12 illustrates another example process flow that can facilitate utilizing local workgroups in a stretched environment, in accordance with an embodiment of this disclosure;

FIG. 13 illustrates an example block diagram of a computer operable to execute an embodiment of this disclosure.

### DETAILED DESCRIPTION

### Overview

The present techniques generally relate to efficiently creating an isolated environment for the user within existing service mesh, and provisioning a stretched environment, where this isolated environment extends to a work group.

It can be that typical microservices environments consist of hundreds or even thousands of the microservices that form a complex graph of dependencies between them. A service mesh can be used in such systems to ease the task of traffic routing, upgrades, access control, etc.

When a new feature or fix is developed, it can be desired to validate this feature or fix as a part of the whole service mesh. For example, if the feature introduces changes even to a single microservice, it can be desired that this microservice is tested as a part of the whole system to make sure that the system behavior is correct and new problems have not been introduced. This can also be relevant to critical production issues that cannot be easily reproduced in a staging environment due to specific production data-it can be desired that such fixes are thoroughly verified in production as a part of the whole service mesh, and without a risk of breaking the whole system.

Prior approaches in this area can generally be as follows. A prior approach can be to perform a simple validation of the microservice locally on a developer's computer, and then to submit the change to a staging environment where the change can be validated manually, and through automated tests.

But in case that the new change introduces a problem, another flow that depends on the changed microservice could become broken until the problem is discovered and resolved. Such an outcome can make the whole environment unusable, especially considering examples where multiple developers work on different microservices, and each one of them might introduce a problem.

Another prior approach can be to create a full copy of the current staging environment, just with the changed microservices instead of the original ones (such as in a separate namespace). Then testing can be performed in this environment, without introducing the problems to the main staging environment. In some examples, the changes will be deployed to the main staging environment only where the tests are successful. This approach can guarantee extra stability for the main staging branch, but can be very expensive—every introduced change can require a full copy of the original environment, which might consist of hundreds of the microservices.

Another prior approach can be to use feature flags to isolate the code changes, so only specific users that were defined per feature flag can reach the changes. It can be that this approach does not provide a complete solution because some changes are too wide and cannot be isolated (e.g., changing significant libraries, database drivers, etc.).

A problem addressed by the present techniques can be how to provision an isolated environment for new changes in such a way that it does not require a full copy of the original environment, and also does not introduce fragility due to multiple broken flows in the same shared environment.

A solution to this problem, according to the present techniques, can be to deploy changed microservices to a shared environment, where their instances can coexist alongside the original unchanged instances. Using a service mesh's capabilities and “deployment validator” information received from a continuous integration/continuous deployment (CI/CD) process, smart routing can be performed: a flow originated by the deployment validator can pass through the changed microservices instances, while a flow originated by other users can pass through the original microservices instances, which are not related to the changes. Microservices that are not related to the changes can be shared by both the deployment validator and other users.

Provisioning of an isolated environment within service mesh based microservice systems can allow deploying and verifying critical patches to an isolated environment directly within production, without effecting real production traffic. This ability can be critical where the problem can be tested/reproduced only in production due to a very specific circumstances/data. Provisioning of an isolated environment can also facilitate increasing development velocity by allowing much faster validation of features/fixes. The isolated environment can be created automatically, and can allow validating features without affecting other people who work in the environment, or, vice versa, being affected by their work in case of any problems in the introduced changes. The isolated environment can facilitate reducing costs associated with provisioning of a full copy of the environment for every change. Producing a full copy for every change can require lots of resources that are not always available in on-premise environments, or cost a lot of money in cloud environments.

In some examples, provisioning of an isolated environment can be a complex task due to the following reasons. There can be hundreds or thousands of microservices that have complex dependencies one on another. There can be multiple users that introduce changes within the same environment to multiple microservices. It can be infeasible to create a full copy of an original environment for every change. Taking these constraints into consideration, there can be a desire for a system that allows each user to have an “illusion” of having its own dedicated environment, even though in reality the environment is shared among dozens or hundreds of users.

In some examples, the present techniques can generally be divided into two parts: deploy time and runtime. In deploy time, there can be isolated environment provisioning, which can allow only a deployment validator's application programming interface (API) calls to pass through changed microservices, while other users' API calls pass through the original versions of the microservices. In runtime, end user information can be propagated through call chains to be able to achieve user-based routing described with respect to deploy time.

The present techniques can be implemented to achieve efficient, automatic provisioning of isolated environments within existing service mesh-based microservices systems. This can facilitate creating a more stable environment, increase development velocity, and make it easier to troubleshoot and validate critical production issues.

There can be techniques for automatically create an isolated environment within a service mesh. An isolated environment can be extended to local developer endpoints, to create a stretched environment. In such a stretched environment's topology, it can be that each developer utilizes only its own local environment without taking advantage of the local environments owned by other developers. The present techniques can be implemented to facilitate a stretched environment across multiple developer local endpoints.

In some scenarios, a developer can utilize only its own local environment without taking advantage of the local environments owned by other developers.

A consequence of this can be that application programming interface (API) calls of each developer are directed to its own local endpoints, and this already takes load off a shared cluster. But this can miss an opportunity to direct API calls of the user to the matching local endpoints of other developers (if such endpoints exist) and take load off the shared cluster even further.

Another consequence of this can be that multiple developers could work on different microservices comprising the same feature. In this situation, it can be that each developer should wait until the changes of other developers that it depends on will be deployed into the shared cluster. This can create a suboptimal development cycle, and thus decreases feature release rate.

In some examples, the present techniques can be implemented among work groups (WG), where developers that belong to the same WG can share their local endpoints with one another. So, an API call to a cluster initiated by a member of one WG can pass through some microservices within the cluster, but if a matching microservice exists in local environment of a member of the WG, the call can be forwarded to that matching microservice in a local environment (instead of forwarding to the microservice within the cluster).

Implementing the present techniques can facilitate creating a stretched isolated environment per group of users that utilizes services within the shared cluster and services within the local workstations of the users in the group.

Benefits of implementing the present techniques can include removing load off a shared cluster; improving, or optimizing, traffic routing using a peer-to-peer approach within a workgroup; and improving a development cycle due to being able to perform joined work on a feature without introducing an inter-user deployment dependency.

The present techniques can be implemented to facilitate a system where developers that belong to the same WG can share their local endpoints with one another, thus improving resource consumption in a shared cluster, and increasing feature release rate.

### EXAMPLE ARCHITECTURES

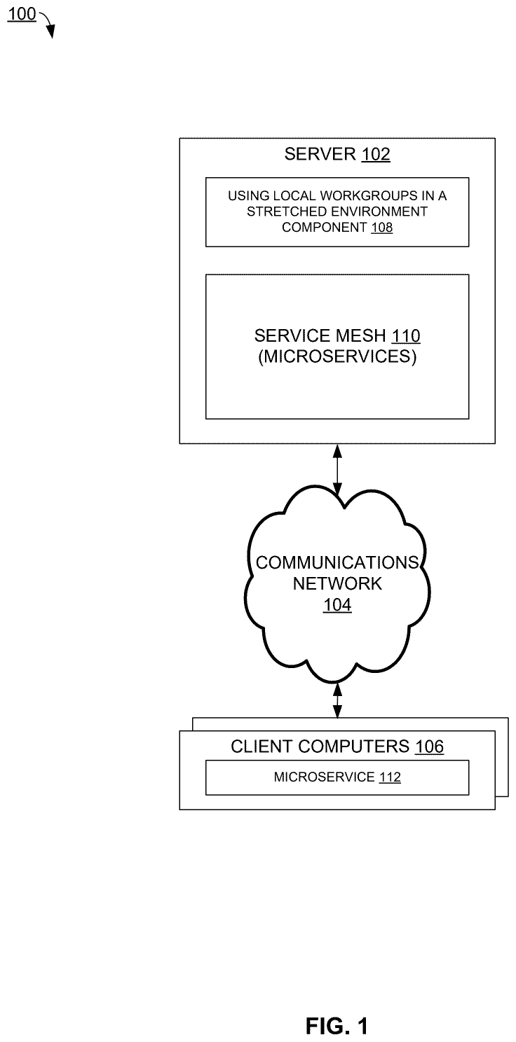

FIG. 1 illustrates an example system architecture 100 that can facilitate utilizing local workgroups in a stretched environment, in accordance with an embodiment of this disclosure.

System architecture 100 comprises server 102, communications network 104, and client computers 106. In turn, server 102 comprises utilizing local workgroups in a stretched environment component 108, and service mesh 110 (microservices). And client computers 106 comprises microservice 112.

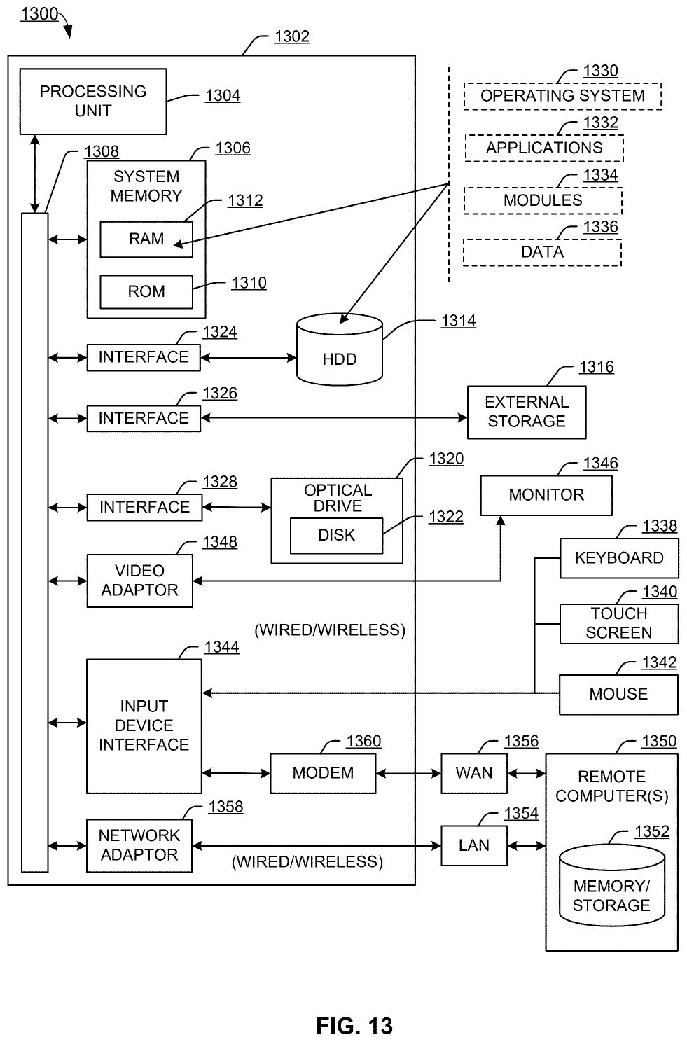

Each of server 102 and/or client computers 106 can be implemented with part(s) of computing environment 1300 of FIG. 13. Communications network 104 can comprise a computer communications network, such as the Internet.

Server 102 can host a service that comprises a group of microservices, and do so within service mesh 110. Utilizing local workgroups in a stretched environment component 108 can receive a changeset for one of those microservices from client computers 106. This changeset can be associated with a user account that submitted the changeset to server 102.

Utilizing local workgroups in a stretched environment component 108 can facilitate incorporating microservice 112 of client computers 106 as part of a stretched environment with service mesh 110 of server 102. Then, requests from client computers 106 to service mesh 110 can be serviced with microservice 112, along with service mesh 110. Different computers of client computers 106 can each access microservice 112, even where it is not hosted on that particular computer.

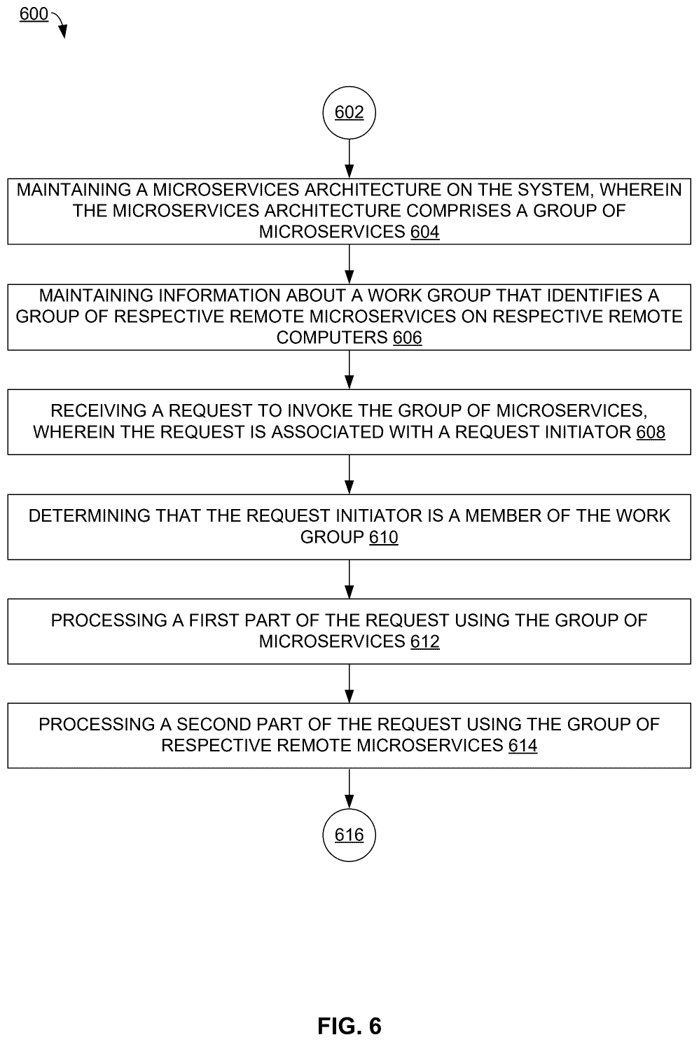

In some examples, utilizing local workgroups in a stretched environment component 108 can implement part(s) of the process flows of FIGS. 6-12 to implement utilizing local workgroups in a stretched environment.

It can be appreciated that system architecture 100 is one example system architecture for utilizing local workgroups in a stretched environment, and that there can be other system architectures that facilitate utilizing local workgroups in a stretched environment.

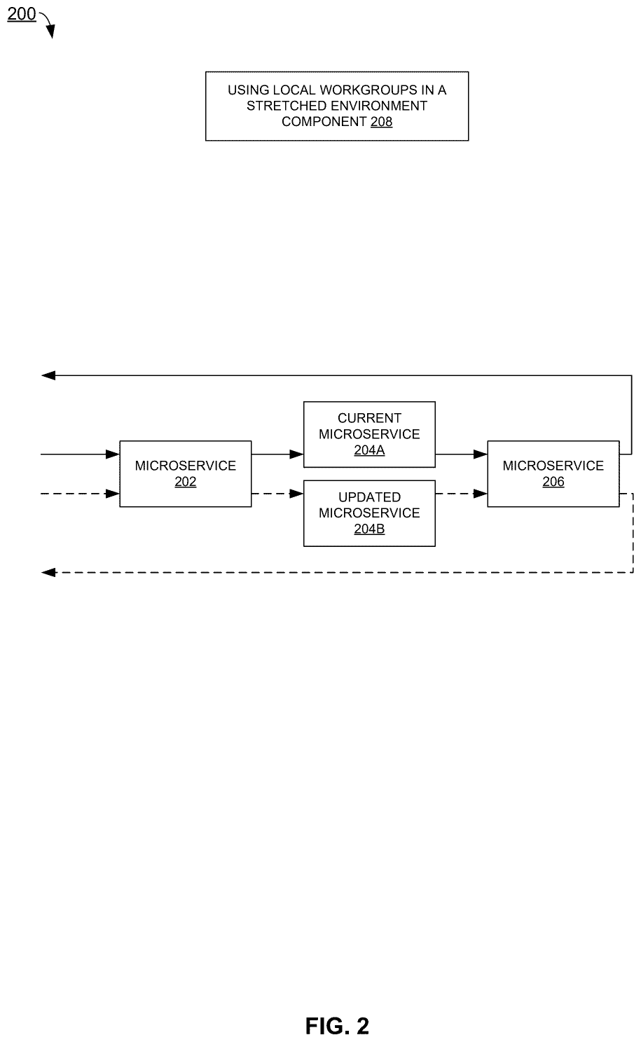

FIG. 2 illustrates another example system architecture 200 that can facilitate utilizing local workgroups in a stretched environment, in accordance with an embodiment of this disclosure. In some examples, part(s) of system architecture 200 can be used to implement a microservices architecture that is hosted by server 102 of FIG. 1 in service mesh 110.

System architecture 200 comprises utilizing local workgroups in a stretched environment component 208 (which can be similar to utilizing local workgroups in a stretched environment component 108 of FIG. 1), microservice 202, current microservice 204A, updated microservice 204B, and microservice 206.

Each of microservice 202, current microservice 204A, updated microservice 204B, and microservice 206 can comprise a computer service that is configured to interact with other microservice(s) via a service mesh to provide a service. A service mesh can generally comprise a dedicated infrastructure layer that facilitates transparently adding capabilities like observability, traffic management, and security without adding them to the code of microservices that run in the service mesh.

Updated microservice 204B can represent an updated version of current microservice 204A, and both can be in operation concurrently. Relative to the example of FIG. 1, updated microservice 204B can be similar to microservice 112 on client computers 106, and current microservice 204A can be a corresponding microservice on service mesh 110.

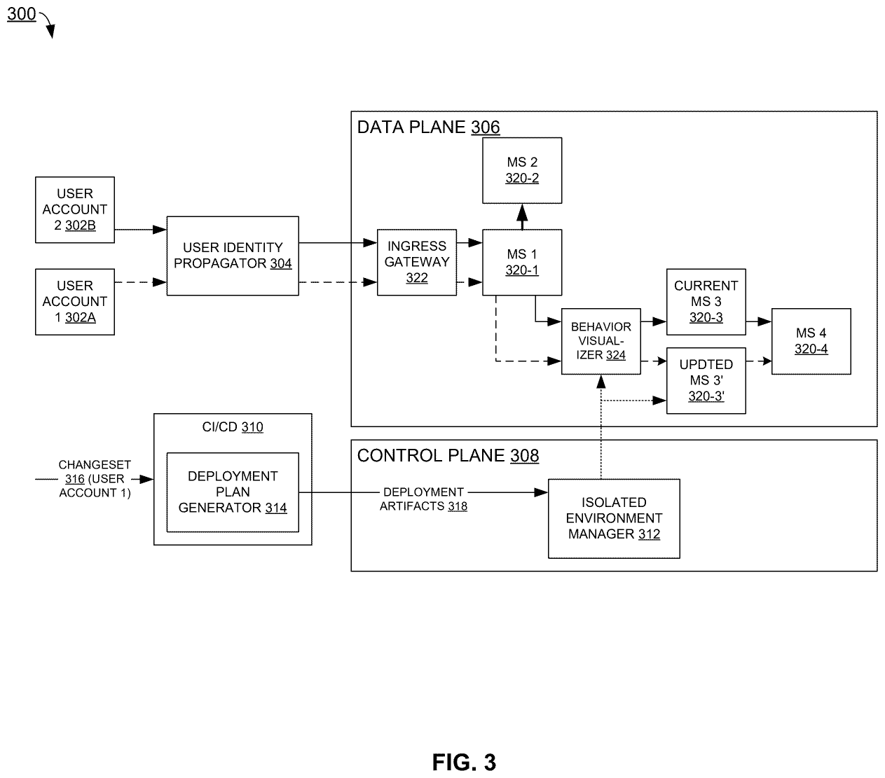

FIG. 3 illustrates another example system architecture 300 that can facilitate utilizing local workgroups in a stretched environment, in accordance with an embodiment of this disclosure. In some examples, part(s) of system architecture 300 can be used to implement part(s) of system architecture 100 of FIG. 1.

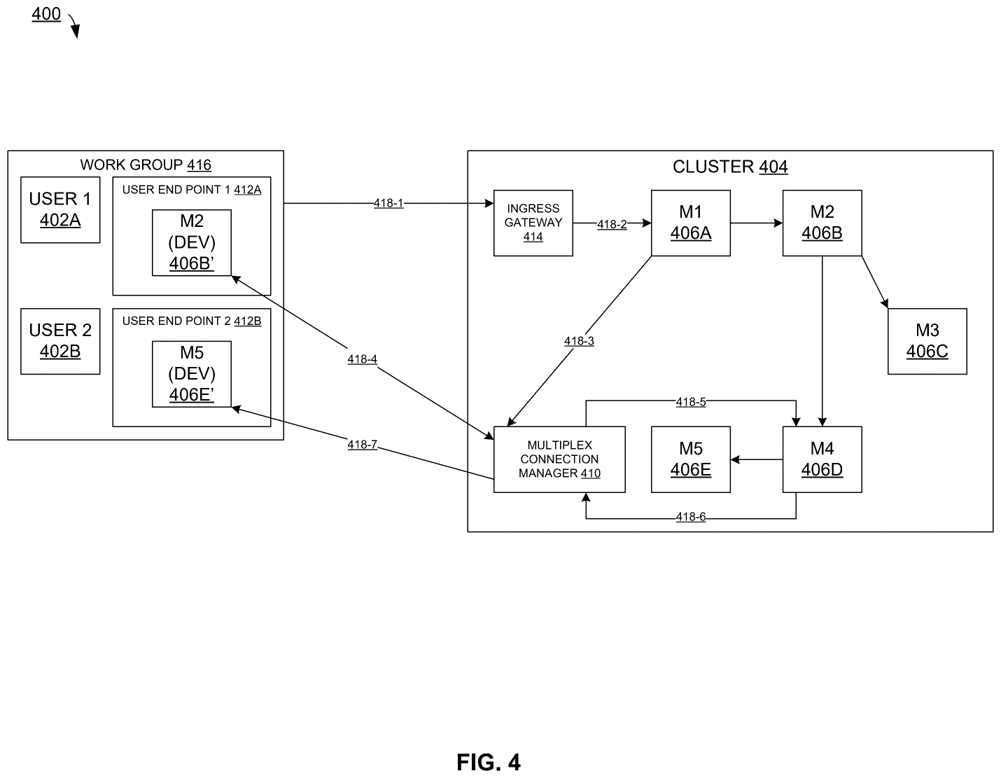

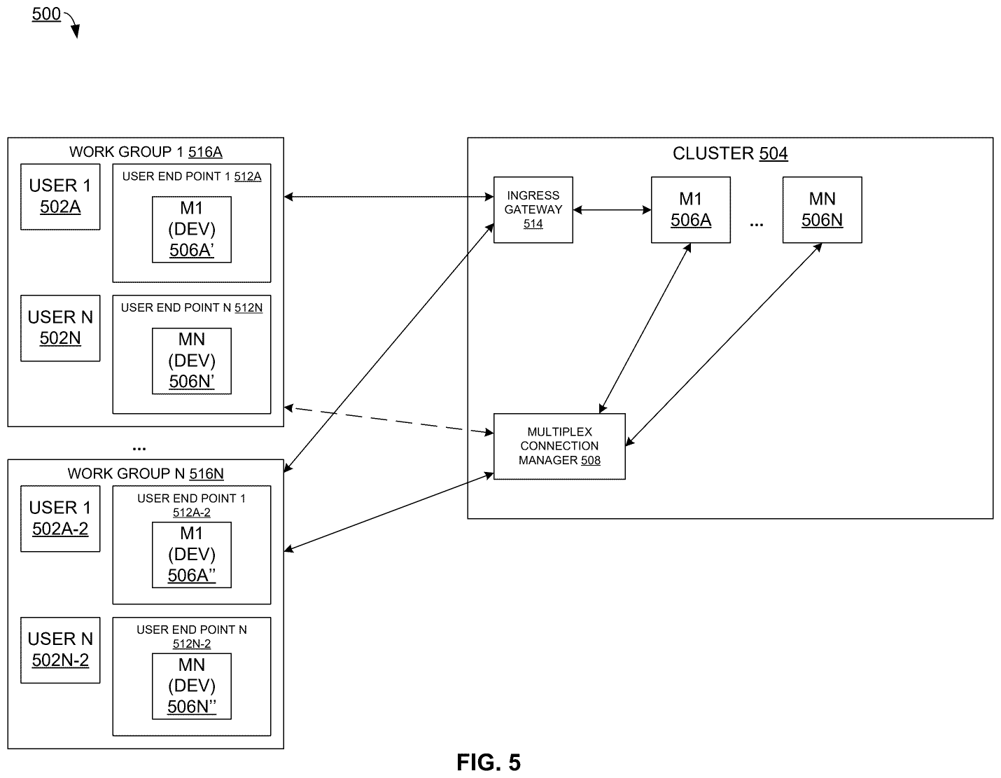

System architecture 300 can generally depict an example where an isolated environment is maintained within a service mesh. In contrast, system architecture 400 of FIG. 4 and system architecture 500 of FIG. 5 can generally depict an example where an isolated environment is stretched to include a work group.

System architecture 300 comprises user account 1 202A and user account 2 202B (which can comprise user account identities in a computing service or device), user identity propagator 304, data plane 306, control plane 308, CI/CD 310, isolated environment manager 312, deployment plan generator 314, changeset 316, deployment artifacts 318, microservice 1 320-1, microservice 2 320-2, current microservice 3 320-3, updated microservice 3′ 320-3′, microservice 4 320-4, ingress gateway 322, and behavior visualizer 324.

User identity propagator 304 can receive an indication of user account 1 302A and/or user account 2 302B and propagate that user identity through the service mesh of data plane 306 so that routing decisions among isolated environments can be made based on user identity. Data plane 306 and control plane 308 can be parts of a service mesh, where data plane 306 carries out policies for microservices in a service mesh (e.g., routing decisions) that are defined by control plane 308.

CI/CD 310 can comprise a continuous integration/continuous delivery service that is configured to integrate changes to the microservices of data plane 306 into data plane 306, and to facilitate deploying those changes to data plane 306. Isolated environment manager 312 can determine routing policies for data plane 306 so that multiple versions of a microservice can coexist in separate isolated environments.

Deployment plan generator 314 can be configured to create deployment artifacts (e.g., deployment artifacts 318) from a changeset (e.g., changeset 316), and these deployment artifacts can be used to set routing policies by isolated environment manager 312. Changeset 316 can comprise a changeset for current microservice 3 320-3 (to create updated microservice 3′ 320-3) that is submitted by user account 1 302A.

Ingress gateway 322 can be configured to load balance incoming requests to a service mesh architecture of data plane 306. Behavior visualizer 324 can be configured to visualize behavior a service mesh architecture of data plane 306 after applying virtual service and destination rules that are generated based on deployment artifacts 318.

Microservice 1 320-1, microservice 2 320-2, current microservice 3 320-3, updated microservice 3′ 320-3′, and microservice 4 320-4 can each be microservices in a service mesh architecture of data plane 306. Updated microservice 3′ 320-3′ can comprise an updated version of current microservice 3 320-3, and there can be separate isolated environments for updated microservice 3′ 320-3′ and current microservice 3 320-3.

Put another way, changeset 316 and an identifier of user account 1 302A can be received by deployment plan generator 314, which can generate deployment artifacts 31. Isolated environment manager 312 can receive deployment artifacts 318 and apply them in order to create updated microservice 3′ 320-3′, as well as adjust routing rules so that traffic of user account 1 302A can be routed to updated microservice 3′ 320-3′.

User account 1 302A and user account 2 302B can execute flows and their corresponding user names can be propagated by user identity propagator 304. So, user account 1 302A can be routed within its isolated environment that includes instances of microservice 1 320-1, microservice 2 320-2, updated microservice 3′ 320-3′, and microservice 4 320-4 through the chain microservice 1 320-1, updated microservice 3′ 320-3′, and microservice 4 320-4. Then user account 2 302B can be routed within its isolated environment that includes instances of microservice 1 320-1, microservice 2 320-2, updated microservice 3 320-3, and microservice 4 320-4 through the chain microservice 1 320-1, updated microservice 3 320-3, and microservice 4 320-4.

A high-level flow can be as follows. Deployment plan generator 314 can be installed in CI/CD 310. Deployment plan generator 314 can generate artifacts (e.g., deployment artifacts 318) needed by the service mesh and deployment orchestrator for creation of a changed microservice's instance (e.g., updated microservice 3′ 320-3′), and for routing traffic for the user that made the change to the changed microservice's instance.

Isolated environment manager 312 can be installed in control plane 308 of the service mesh, and apply service mesh artifacts that are received from the deployment plan generator. Service mesh artifacts can comprise, e.g., a YAML or JSON file. Service mesh artifacts can reference a microservice image that an instance of a microservice is to be created from, as well as additional information such as what labels to put and how many instances to process.

User identity propagator 304 can be installed as a plugin within a web browser, and can pass a user name of a logged in user as a special header value so that routing rules created by the deployment plan generator can act upon the header value in order to route the traffic to the changed microservice instance (e.g., updated microservice 3′ 320-3′) only for a user who made the change.

That is, relative to a prior system architecture, changes can be introduced to a CI/CD process, a service mesh, and a running application to integrate between those three systems in order to achieve automatic provisioning of the isolated environment.

Generating a deployment plan can be performed as follows. Deployment plan generator 314 can be installed in CI/CD 310. A developer submitting the changes can pass a <username> (which can be later used to login to the application) to CI/CD 310 as an input. Deployment plan generator 314 can receive the <username> from CI/CD 310, and can generate service mesh artifacts (e.g., deployment artifacts 318; in some examples, these can be files in a human-readable format, such as Yet Another Markup Language (YAML) or JavaScript Object Notation (JSON) files) that can allow creating a new instance of the microservice, where the new instance is marked with a special label. The value of this label can be set to <username>.

In addition, deployment plan generator 314 can generate artifacts in deployment artifacts 318 that are used to adjust routing rules to allow only traffic with a special header that matches the label to reach the changed microservice instance.

Note that a service mesh can generally comprise a dedicated infrastructure layer that allows transparently adding capabilities, like observability, traffic management, and security without adding them to microservices code. With the present techniques, a service mesh's traffic management capability can be used in order to create an isolated environment for a target user.

The following example can illustrate the present techniques, as they relate to artifacts generation for creating an isolated environment for user test_user1. This can be an orchestration deployment artifact that is intended for use for any user in its application, so its label named “user” has a value of “any.” The image name can be jsmith/orders:
kind: Deployment
metadata:
   name: orders
spec:
   replicas: 1
   selector:
      matchLabels:
         app: orders
   template:
      metadata:
         labels:
         app: orders
         user: any
      spec:
         containers:
         name: orders
         image: jsmith/orders
         ports:
         containerPort: 8080

The following can be an orchestration deployment artifact that is created specifically for test_user1, so its label named “user” has value “test_user1.” The image of the microservice here is named jsmith/orders-v2-it contains a change that was submitted by a user who will validate the change using username “test_user1.”
kind: Deployment
metadata:
   name: orders
spec:
   replicas:1
   selector:
      matchLabels:
         app: orders
   template:
      metadata:
         labels:
         app: orders
         user: test_user1
      spec:
         containers:
         -name: orders
         image: jsmith/orders-v2
         ports:
         containerPort: 8080

The following can be a service mesh destination rule artifact that facilitates dividing incoming traffic to subsets. Here, traffic can be divided using a “user” label that is presented in the orchestrator's deployment artifact listed above. So, here, a new subset named “test_user1” is added to an existing destination rule.
kind: DestinationRule
metadata:
   name: orders-destination-rule
spec:
   host: orders-svc
   subsets:
      name: test_user1
      labels:
         user: test_user1
      name: any
      labels:
         user: any

The following can be a service mesh's virtual service artifact. A part can be added that permits checking for a value of an end-user header, and if it is equal to test_user1, then the traffic can be routed to a subset named test_user1. This can mean that traffic will reach the microservice created off the image jsmith/orders-v2 that contains the change introduced by the user testing with test_user1.
kind: VirtualService
metadata:
   name: reviews
spec:
   hosts:
      reviews
   http:
      match:
         headers:
         end-user:
         exact: test_users1
      route:
         destination:
         host: orders-svc
         subset: test_user1
      route:
         destination:
         host: orders-svc
         subset: any

Isolated environment management can be performed as follows. An isolated environment manager can be installed in a control plane of the service mesh and can apply the service mesh artifacts received from the deployment plan generator in order to provision the new microservice instance with the required label, and adjust routing rules accordingly.

Later, when a user finishes its tasks within the environment, the isolated environment manager can be used to revert back all changes that were applied to create the isolated environment.

So, in the case of the previous example, to revert back all the changes can mean removing the corresponding snippets from a virtual service, destination rule and redeploy those artifacts, then apply the removal of the corresponding orchestration deployment file. That is, the changes can be applied in a reverse order as a creation flow. For removing the isolated environment, it can be that all the configuration changes related to it are removed, and apply this so that service mesh adjusts accordingly. For example, where the virtual service has a specific configuration per test_user1-it can be removed and the service mesh can be informed that it is no longer relevant. That is, this can be removed from deployment artifacts:
http:
   match:
      headers:
      end-user:
         exact: test_users1
route:
   destination:
      host: orders-svc
      subset: test_user1

Similarly, this can be removed from deployment artifacts for a destination rule:
subsets:
   name: test_user1
      labels:
         user: test_user1

A user identity can be propagated as follows. A user identity propagator can be installed as a plugin within a web browser, or in addition to an application itself. The user identity propagator can take a <username> that was used to login, and can set a dedicated header named end-user with a value equal to <username>.

An end-user header can be propagated between microservices that are participating in the call chain. For this purpose, a dedicated interceptor can be used that can catch an incoming request, fetch an end-user header, and put it on an outgoing request.

An alternative approach can be to take a dedicated library, and configure it to handle an end-user header.

It can be that each flow originating from a browser can include an end-user header with the <username> value above. The value of the header can be consumed by routing rules generated by the deployment plan generator in order to route the traffic of the logged in <username> to its own dedicated microservice instances that were created previously through the corresponding deployment.

It can be that some service meshes can deduce a user from tokens (e.g., JSON web tokens (JWT tokens), and use those for routing.

FIG. 4 illustrates another example system architecture 400 that can facilitate utilizing local workgroups in a stretched environment, in accordance with an embodiment of this disclosure. In some examples, part(s) of system architecture 400 can be used to implement part(s) of system architecture 100 of FIG. 1.

System architecture 400 comprises user 1 402A and user 2 402B; cluster 404; microservices M1 406A, M2 406B, M4 406D, and M5 406E; microservices M2 (dev) 406B′ and M5 (dev) 406E′; multiplex connection manager 408; user end point 1 412A and user end point 2 412B; ingress gateway 414; work group 416; and signal 418-1, signal 418-2, signal 418-3, signal 418-4, signal 418-5, signal 418-6, and signal 418-7.

In system architecture 400, user 1 402A initiates a request to cluster 404, and the request would pass through microservices M1 406A, M2 406B, M4 406D, and M5 406E (in examples where the present techniques are not implemented). But in system architecture 400, user 1 402A owns M2 (dev) 406B′ and user 2 402B (who belongs to the same WG as user 1 402A) owns M5 (dev) 406E′. Hence, the local microservices of the WG's developers can be preferred over the microservices of cluster 404, and the final API call chain can become M1 406A, M2 (dev) 406B′, M4 406D, and M5 (dev) 406E′.

A WG can be defined as {identifier of the WG, set of developers in WG, set of microservices owned by each developer}.

Upon creation or change of a local WG by an environment operator, the definition of the WG can be shared with multiplex connection manager 408 and a requests redirection proxy. Each user communication agent (e.g., user communication agent 412A and user communication agent 412B) can receive updates about creation and changes of the WG related to its user.

A requests redirection proxy can perform the following:

Check if a request initiator belongs to a set of developers of any of the available WGs.

Check if a request target (the target microservice) is owned by any of the developers of the found WG.

If Yes, direct the request to multiplex connection manager 408 for further forwarding to appropriate local environment.

Otherwise, route the request to a microservice within the cluster.

Multiplex connection manager 408 can perform traffic management as follows. In addition to the information about available WGs, multiplex connection manager 408 can maintain a mapping between each user and a connection to its local environment. Hence, multiplex connection manager 408 can perform the following:

Find the WG of request initiator.

Find the developer within WG who owns the microservice to which the request should be directed.

Fetch a connection associated with the found developer.

Write request details to the obtained connection.

A user communication agent can perform the following to facilitate peer-to-peer communication.

In a case where a request from a developer local endpoint is directed to a microservice that is owned by a developer in the same WG, the user communication agent can open a peer-to-peer connection with that user's user communication agent. This can facilitate bypassing a roundtrip to multiplex connection manager 408, and improve the communication even further.

FIG. 5 illustrates another example system architecture 500 that can facilitate utilizing local workgroups in a stretched environment, in accordance with an embodiment of this disclosure. In some examples, part(s) of system architecture 500 can be used to implement part(s) of system architecture 100 of FIG. 1.

System architecture 500 comprises user 1 502A, user N 502N, user 1 502A-2, and user N 502N-2; cluster 504; microservices M1 506A and MN 506N; microservices M1 (dev) 506A′, MN (dev) 506N′, M1 (dev) 506A″, and MN (dev) 506N″; multiplex connection manager 508; user end point 1 512A, user end point N 512N, user end point 1 512A-2, and user end point N 512N-2; ingress gateway 514; and work group 1 516A and work group N 516N.

System architecture 500 illustrates a scenario where multiple stretched isolated environments are created. Each stretched isolated environment comprises microservices within the shared cluster and local microservices (end points) owned by the users of the corresponding work group.

### EXAMPLE PROCESS FLOWS

FIG. 6 illustrates an example process flow 600 that can facilitate utilizing local workgroups in a stretched environment, in accordance with an embodiment of this disclosure. In some examples, one or more embodiments of process flow 600 can be implemented by utilizing local workgroups in a stretched environment component 108 of FIG. 1, or computing environment 1300 of FIG. 13.

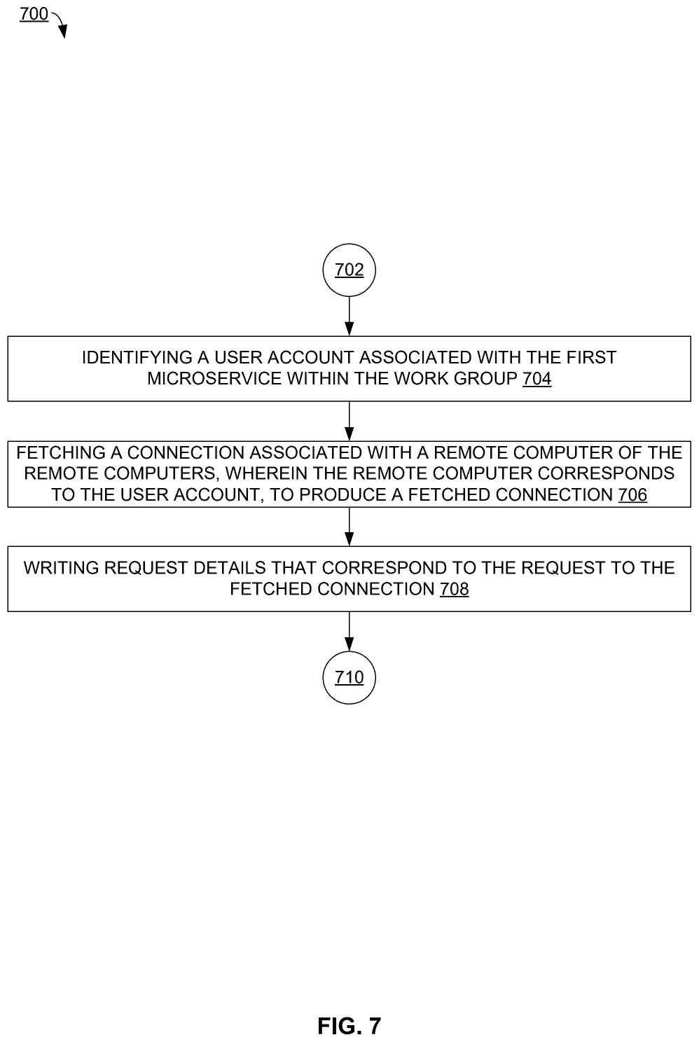

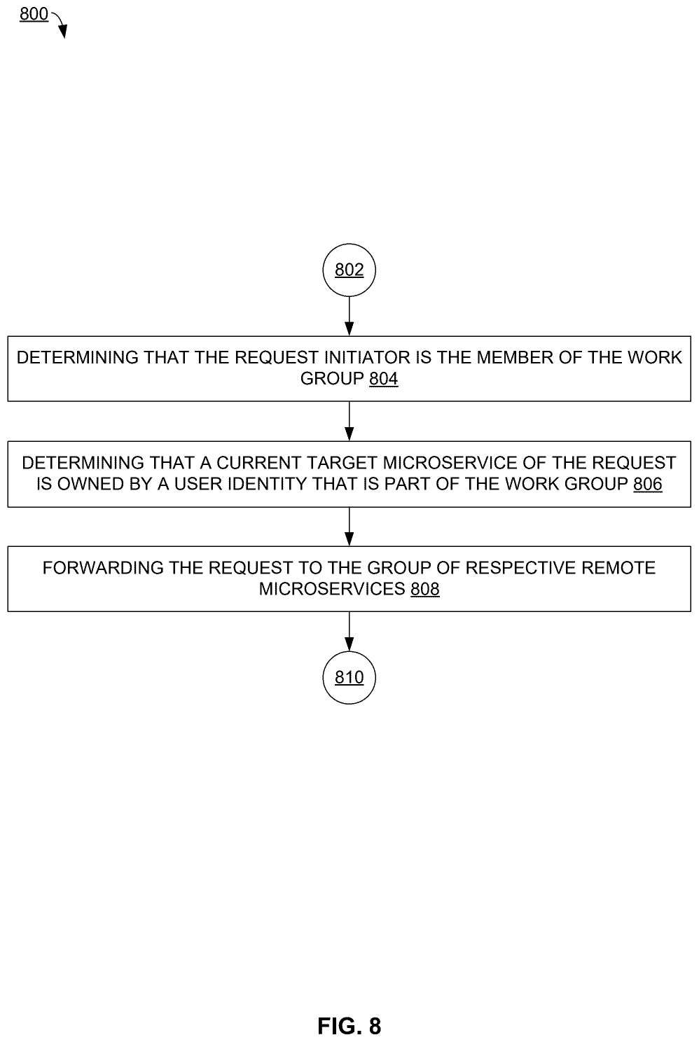

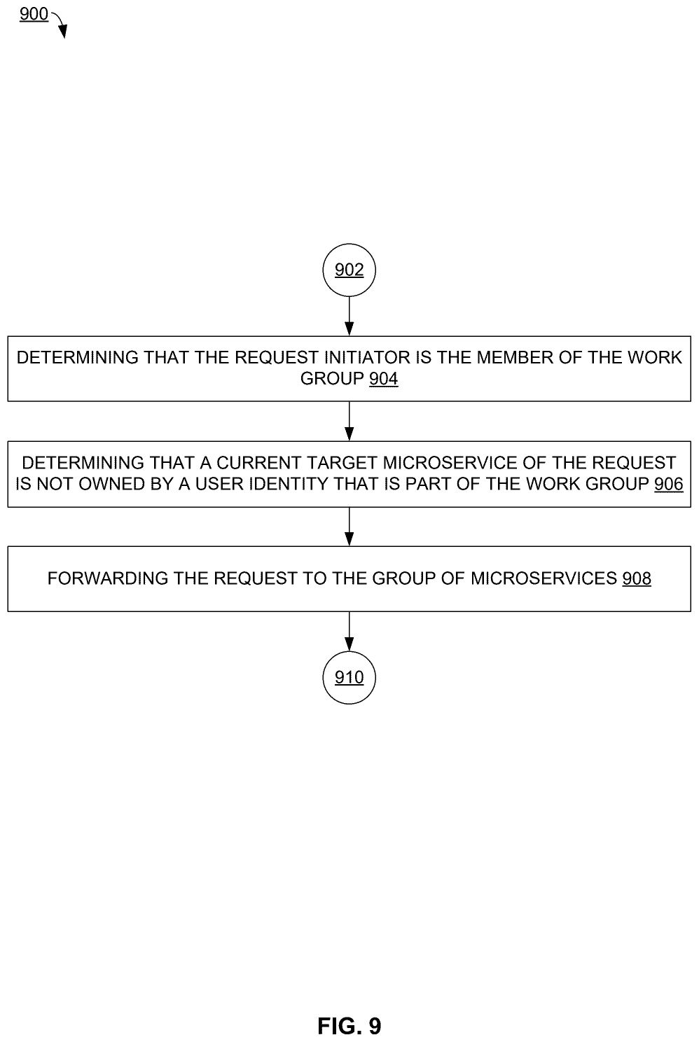

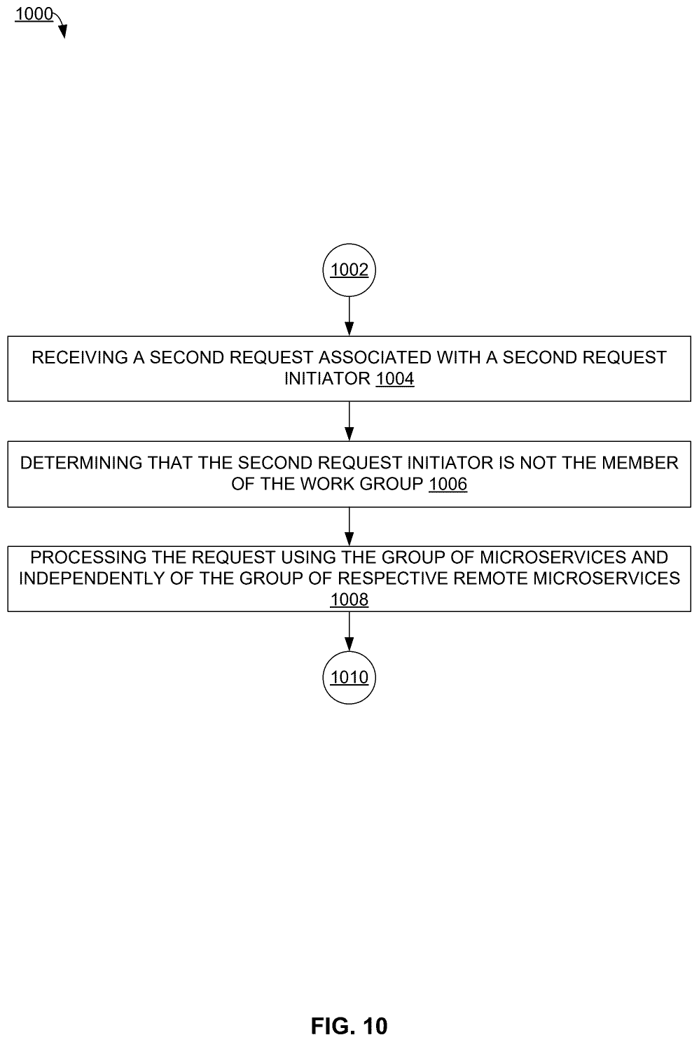

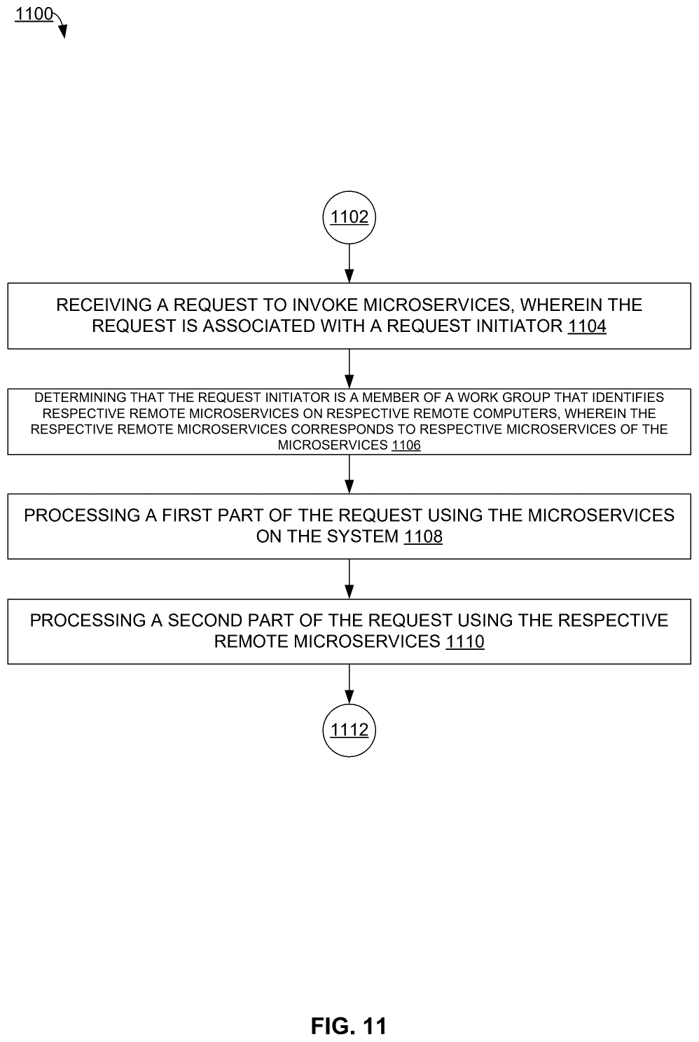

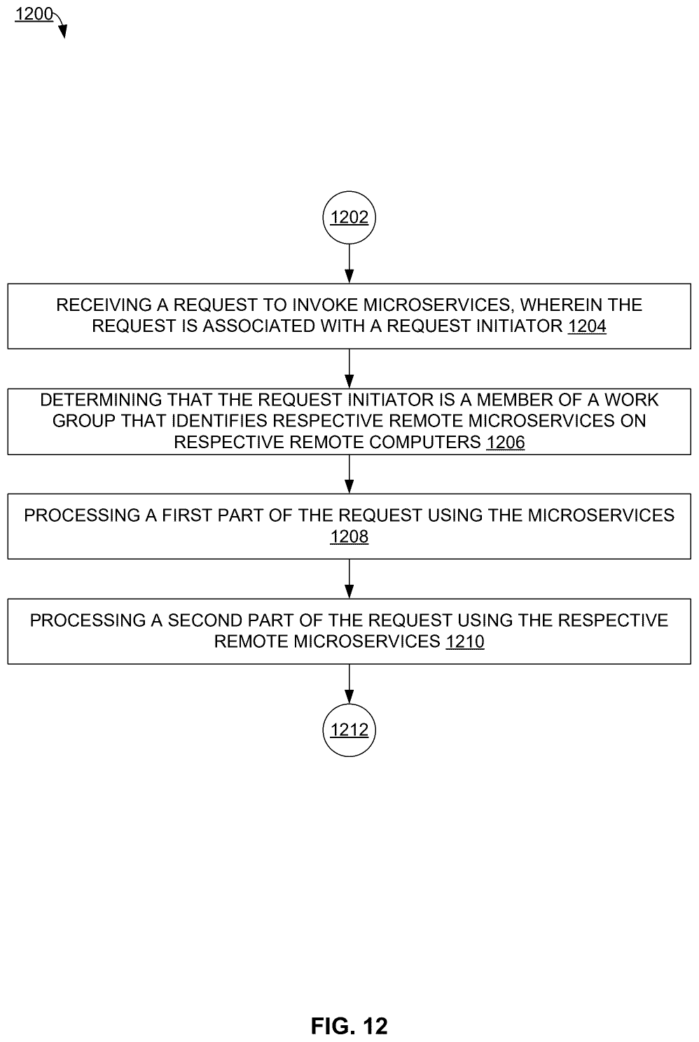

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 700 of FIG. 7, process flow 800 of FIG. 8, process flow 900 of FIG. 9, process flow 1000 of FIG. 10, process flow 1100 of FIG. 11, and/or process flow 1200 of FIG. 12.

Process flow 600 begins with 602, and moves to operation 604.

Operation 604 depicts maintaining a microservices architecture on the system, wherein the microservices architecture comprises a group of microservices. This can be similar to the microservices of cluster 404 of FIG. 4 and/or cluster 504 of FIG. 5.

After operation 604, process flow 600 moves to operation 606.

Operation 606 depicts maintaining information about a work group that identifies a group of respective remote microservices on respective remote computers. This can be similar to work group 416 of FIG. 4, and/or work group 1 516A and work group N 516N of FIG. 5.

After operation 606, process flow 600 moves to operation 608.

Operation 608 depicts receiving a request to invoke the group of microservices, wherein the request is associated with a request initiator. This can be similar to 418-1 of FIG. 1.

After operation 608, process flow 600 moves to operation 610.

Operation 610 depicts determining that the request initiator is a member of the work group.

In some examples, a group of work groups comprises the work group, and determining that the request initiator is the member of the work group comprises determining, from the group of work groups, that the request initiator is the member of the work group. Using the example of FIG. 5, there can be work group 1 516A and work group N 516N, and it can be determined that the requestor is a member of work group 1 516A.

After operation 610, process flow 600 moves to operation 612.

Operation 612 depicts processing a first part of the request using the group of microservices.

After operation 612, process flow 600 moves to operation 614. Using the example of FIG. 4, this can comprise authenticating the request, and/or processing the request with M1 406A and M4 406D.

Operation 614 depicts processing a second part of the request using the group of respective remote microservices. Using the example of FIG. 4, this can comprise processing the request with M2 (dev) 406B′ and M5 (dev) 406E′.

After operation 612, process flow 600 moves to 614, where process flow 600 ends.

FIG. 7 illustrates an example process flow 700 that can facilitate utilizing local workgroups in a stretched environment, in accordance with an embodiment of this disclosure. In some examples, one or more embodiments of process flow 700 can be implemented by utilizing local workgroups in a stretched environment component 108 of FIG. 1, or computing environment 1300 of FIG. 13.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 600 of FIG. 6, process flow 800 of FIG. 8, process flow 900 of FIG. 9, process flow 1000 of FIG. 10, process flow 1100 of FIG. 11, and/or process flow 1200 of FIG. 12.

In some examples, process flow 700 can be implemented in conjunction with process flow 600 to facilitate processing the second part of the request using the group of respective remote microservices. Additionally, process flow 700 can be performed based on determining to process the request using a first microservice of the group of respective remote microservices instead of a second microservice of the group of microservices.

Process flow 700 begins with 702, and moves to operation 704.

Operation 704 depicts identifying a user account associated with the first microservice within the work group. That is a work group of the request identifier can be determined.

In some examples, the first microservice corresponds to an updated version of the second microservice. That is, the first microservice can be M2 (dev) 406B′ and the second microservice can be M2 406B.

After operation 704, process flow 700 moves to operation 706.

Operation 706 depicts fetching a connection associated with a remote computer of the remote computers, wherein the remote computer corresponds to the user account, to produce a fetched connection. That is, a user account within a work group that owns the microservice to which the request is to be directed can be identified.

After operation 706, process flow 700 moves to operation 708.

Operation 708 depicts writing request details that correspond to the request to the fetched connection.

In some examples, the identifying, the fetching, and the writing are performed by a connection manager of the system that is separate from the group of microservices. This can be similar to multiplex connection manager 408 of FIG. 4.

After operation 708, process flow 700 moves to 710, where process flow 700 ends.

FIG. 8 illustrates an example process flow 800 that can facilitate utilizing local workgroups in a stretched environment, in accordance with an embodiment of this disclosure. In some examples, one or more embodiments of process flow 800 can be implemented by utilizing local workgroups in a stretched environment component 108 of FIG. 1, or computing environment 1300 of FIG. 13.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 600 of FIG. 6, process flow 700 of FIG. 7, process flow 900 of FIG. 9, process flow 1000 of FIG. 10, process flow 1100 of FIG. 11, and/or process flow 1200 of FIG. 12.

In some examples, process flow 800 can be implemented in conjunction with process flow 600 of FIG. 6 to facilitate processing the first part of the request using the group of microservices, and processing the second part of the request using the group of respective remote microservices.

Process flow 800 begins with 802, and moves to operation 804.

Operation 804 depicts determining that the request initiator is the member of the work group.

After operation 804, process flow 800 moves to operation 806. That is, a check can be made for whether the request initiator belongs to a group of user accounts in any of the available work groups.

Operation 806 depicts determining that a current target microservice of the request is owned by a user identity that is part of the work group. That is, a check can be made for whether the request target microservice is owned by any of the user accounts of the found work group.

After operation 806, process flow 800 moves to operation 808.

Operation 808 depicts forwarding the request to the group of respective remote microservices. This can comprise directing the request to a multiplex connection manager (e.g., multiplex connection manager 408 of FIG. 4) for further forwarding to an appropriate local environment of the current target microservice.

After operation 808, process flow 800 moves to 810, where process flow 800 ends.

FIG. 9 illustrates an example process flow 900 that can facilitate utilizing local workgroups in a stretched environment, in accordance with an embodiment of this disclosure. In some examples, one or more embodiments of process flow 900 can be implemented by utilizing local workgroups in a stretched environment component 108 of FIG. 1, or computing environment 1300 of FIG. 13.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 600 of FIG. 6, process flow 700 of FIG. 7, process flow 800 of FIG. 8, process flow 1000 of FIG. 10, process flow 1100 of FIG. 11, and/or process flow 1200 of FIG. 12.

In some examples, process flow 900 can be implemented in conjunction with process flow 600 of FIG. 6 to facilitate processing the first part of the request using the group of microservices, and processing the second part of the request using the group of respective remote microservices.

Process flow 900 begins with 902, and moves to operation 904.

Operation 904 depicts determining that the request initiator is the member of the work group. This can be implemented in a similar manner as operation 804 of FIG. 8.

After operation 904, process flow 900 moves to operation 906.

Operation 906 depicts determining that a current target microservice of the request is not owned by a user identity that is part of the work group. This can be implemented in a similar manner as operation 806 of FIG. 8 (where the result is the opposite).

After operation 906, process flow 900 moves to operation 908.

Operation 908 depicts forwarding the request to the group of microservices. That is, where there is not a remote microservice in a work group to send the request to, the request can be sent to a microservice in a cluster.

After operation 908, process flow 900 moves to 910, where process flow 900 ends.

FIG. 10 illustrates an example process flow 1000 that can facilitate utilizing local workgroups in a stretched environment, in accordance with an embodiment of this disclosure. In some examples, one or more embodiments of process flow 1000 can be implemented by utilizing local workgroups in a stretched environment component 108 of FIG. 1, or computing environment 1300 of FIG. 13.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 600 of FIG. 6, process flow 700 of FIG. 7, process flow 800 of FIG. 8, process flow 900 of FIG. 9, process flow 1100 of FIG. 11, and/or process flow 1200 of FIG. 12.

In some examples, where process flow 1000 is implemented in conjunction with process flow 600 of FIG. 6, the request is a first request, and the request initiator is a first request initiator.

Process flow 1000 begins with 1002, and moves to operation 1004.

Operation 1004 depicts receiving a second request associated with a second request initiator. This can be implemented in a similar manner as operation 608 of FIG. 6.

After operation 1004, process flow 1000 moves to operation 1006.

Operation 1006 depicts determining that the second request initiator is not the member of the work group. This can be implemented in a similar manner as operation 804 of FIG. 8 (with the opposite result).

After operation 1006, process flow 1000 moves to operation 1008.

Operation 1008 depicts processing the request using the group of microservices and independently of the group of respective remote microservices. That is, where there is not a remote microservice for a work group that the request initiator is a member of, it can be processed locally on a microservice of a cluster rather than sent to a computer of the work group.

After operation 1008, process flow 1000 moves to 1010, where process flow 1000 ends.

FIG. 11 illustrates an example process flow 1100 that can facilitate utilizing local workgroups in a stretched environment, in accordance with an embodiment of this disclosure. In some examples, one or more embodiments of process flow 1100 can be implemented by utilizing local workgroups in a stretched environment component 108 of FIG. 1, or computing environment 1300 of FIG. 13.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 600 of FIG. 6, process flow 700 of FIG. 7, process flow 800 of FIG. 8, process flow 900 of FIG. 9, process flow 1000 of FIG. 10, and/or process flow 1200 of FIG. 12.

Process flow 1100 begins with 1102, and moves to operation 1104.

Operation 1104 depicts receiving a request to invoke microservices, wherein the request is associated with a request initiator. In some examples, operation 1104 can be implemented in a similar manner as operation 608 of FIG. 6.

After operation 1104, process flow 1100 moves to operation 1106.

Operation 1106 depicts determining that the request initiator is a member of a work group that identifies respective remote microservices on respective remote computers, wherein the respective remote microservices corresponds to respective microservices of the microservices. In some examples, operation 1106 can be implemented in a similar manner as operation 610 of FIG. 6.

In some examples, the work group comprises a first identifier of the work group, a second identifier of a group of user accounts in the work group, and a third identifier of the respective remote microservices. That is, a work group can be defined as {identifier of the WG, set of developers in WG, set of microservices owned by each developer}.

In some examples, operation 1106 comprises, based on changing the work group to produce a changed work group, communicating, the changed work group to a multiplex connection manager of the system that is configured to maintain at least one respective connection with at least one of the respective computers. This can be similar to multiplex connection manager 408 of FIG. 4, or multiplex connection manager 508 of FIG. 5.

In some examples, operation 1106 comprises, based on changing the work group to produce a changed work group, communicating, the changed work group to a requests redirection proxy of the system that is configured to intercept and redirect requests that are incoming to a microservice of the microservices or that are outgoing from the microservice. This can be similar to a requests redirection proxy as described herein.

In some examples, operation 1106 comprises, based on changing the work group to produce a changed work group, communicating, the changed work group to a user communication agent of a remote computer of the remote computers, wherein the user communication agent is configured to maintain a communication channel with the system. In some examples, the communicating is performed based on determining that the remote computer is associated with a user account that is the member of the work group. In some examples, the user communication agent is a first user communication agent, the remote computer is a first remote computer, and this comprises refraining, from communicating the changed work group to a second user communication agent of a second remote computer, based on the second remote computer being determined to lack a user account that is the member of the work group.

In some examples, this can be similar to user end point 1 412A and/or user end point 2 412B of FIG. 4. Using the example of FIG. 5, where the change is made to work group 1 516A, the change can be communicated to user end point 1 512A, user end point N 512N, and not communicated to user end point 1 512A-2 and user end point N 512N-2.

After operation 1106, process flow 1100 moves to operation 1108.

Operation 1108 depicts processing a first part of the request using the microservices on the system. In some examples, operation 1108 can be implemented in a similar manner as operation 612 of FIG. 6.

After operation 1108, process flow 1100 moves to operation 1110.

Operation 1110 depicts processing a second part of the request using the respective remote microservices. In some examples, operation 1110 can be implemented in a similar manner as operation 614 of FIG. 6.

After operation 1110, process flow 1100 moves to 1112, where process flow 1100 ends.

FIG. 12 illustrates an example process flow 1200 that can facilitate utilizing local workgroups in a stretched environment, in accordance with an embodiment of this disclosure. In some examples, one or more embodiments of process flow 1200 can be implemented by utilizing local workgroups in a stretched environment component 108 of FIG. 1, or computing environment 1300 of FIG. 13.

It can be appreciated that the operating procedures of process flow 1200 are example operating procedures, and that there can be embodiments that implement more or fewer operating procedures than are depicted, or that implement the depicted operating procedures in a different order than as depicted. In some examples, process flow 1200 can be implemented in conjunction with one or more embodiments of one or more of process flow 600 of FIG. 6, process flow 700 of FIG. 7, process flow 800 of FIG. 8, process flow 900 of FIG. 9, process flow 1000 of FIG. 10, and/or process flow 1100 of FIG. 11.

Process flow 1200 begins with 1202, and moves to operation 1204.

Operation 1204 depicts receiving a request to invoke microservices, wherein the request is associated with a request initiator. In some examples, operation 1204 can be implemented in a similar manner as operation 608 of FIG. 6.

After operation 1204, process flow 1200 moves to operation 1206.

Operation 1206 depicts determining that the request initiator is a member of a work group that identifies respective remote microservices on respective remote computers. In some examples, operation 1206 can be implemented in a similar manner as operation 610 of FIG. 6.

In some examples, a group of work groups comprises the work group, and wherein a system that implements process flow 1200 is configured to process respective requests using respective combinations of respective remote microservices of respective groups of the group of work groups and the microservices. That is, there can be multiple work groups, such as with work group 1 516A and work group N 516N of FIG. 5.

In some examples, the microservices and the respective remote microservices comprise a stretched isolated environment for a first user account that is isolated from access by a second user account that has access to the microservices. Using the example of FIG. 5, work group 1 516A can comprise a stretched isolated environment that is isolated from work group N 516N (or another user account that is not a member of work group 1 516A).

After operation 1206, process flow 1200 moves to operation 1208.

Operation 1208 depicts processing a first part of the request using the microservices. In some examples, operation 1208 can be implemented in a similar manner as operation 610 of FIG. 6.

After operation 1208, process flow 1200 moves to operation 1210.

Operation 1210 depicts processing a second part of the request using the respective remote microservices. In some examples, operation 1210 can be implemented in a similar manner as operation 614 of FIG. 6.

In some examples, processing the second part of the request using the respective remote microservices comprises invoking a first remote microservice of the respective remote microservices, the first remote microservice invoking a second remote microservice of the respective remote microservices via a peer-to-peer connection. That is, traffic routing can involve peer-to-peer communication within a work group.

In some examples, processing the second part of the request using the respective remote microservices corresponds to a first load on the system, invoking a group of microservices of the microservices that is local to the system and that corresponds to the respective remote microservices corresponds to a second load on the system, and the first load is less than the second load. That is, implementing the present techniques can lower a load on a shared cluster (e.g., cluster 404 of FIG. 4 and/or cluster 504 of FIG. 5).

After operation 1210, process flow 1200 moves to 1212, where process flow 1200 ends.

### EXAMPLE OPERATING ENVIRONMENT

In order to provide additional context for various embodiments described herein, FIG. 13 and the following discussion are intended to provide a brief, general description of a suitable computing environment 1300 in which the various embodiments of the embodiment described herein can be implemented.

For example, parts of computing environment 1300 can be used to implement one or more embodiments of server 102 and/or client computers 106 of FIG. 1, cluster 404, user end point 1 412A, and/or user end point 2 412B of FIG. 4, and/or cluster 504, end point 1 512A, user end point N 512N, user end point 1 512A-2, and/or user end point N 512N-2 of FIG. 5.

In some examples, computing environment 1300 can implement one or more embodiments of the process flows of FIGS. 6-12 to facilitate utilizing local workgroups in a stretched environment.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 13, the example environment 1300 for implementing various embodiments described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a nonvolatile storage such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), one or more external storage devices 1316 (e.g., a magnetic floppy disk drive (FDD) 1316, a memory stick or flash drive reader, a memory card reader, etc.) and an optical disk drive 1320 (e.g., which can read or write from a CD-ROM disc, a DVD, a BD, etc.). While the internal HDD 1314 is illustrated as located within the computer 1302, the internal HDD 1314 can also be configured for external use in a suitable chassis (not shown). Additionally, while not shown in environment 1300, a solid state drive (SSD) could be used in addition to, or in place of, an HDD 1314. The HDD 1314, external storage device(s) 1316 and optical disk drive 1320 can be connected to the system bus 1308 by an HDD interface 1324, an external storage interface 1326 and an optical drive interface 1328, respectively. The interface 1324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the. NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can be also connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are examples, and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” “data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
maintaining a microservices architecture on the system, wherein the microservices architecture comprises a group of microservices;
maintaining information about a work group that identifies a group of respective remote microservices on respective remote computers;
receiving a request to invoke the group of microservices, wherein the request is associated with a request initiator;
determining that the request initiator is a member of the work group;
processing a first part of the request using the group of microservices; and
processing a second part of the request using the group of respective remote microservices.

2. The system of claim 1, wherein processing the second part of the request using the group of respective remote microservices comprises:
based on determining to process the request using a first microservice of the group of respective remote microservices instead of a second microservice of the group of microservices,
identifying a user account associated with the first microservice within the work group,
fetching a connection associated with a remote computer of the remote computers, wherein the remote computer corresponds to the user account, to produce a fetched connection, and
writing request details that correspond to the request to the fetched connection.

3. The system of claim 2, wherein the first microservice corresponds to an updated version of the second microservice.

4. The system of claim 2, wherein the identifying, the fetching, and the writing are performed by a connection manager of the system that is separate from the group of microservices.

5. The system of claim 1, wherein processing the first part of the request using the group of microservices, and processing the second part of the request using the group of respective remote microservices comprises:
based on determining that the request initiator is the member of the work group, and based on determining that a current target microservice of the request is owned by a user identity that is part of the work group, forwarding the request to the group of respective remote microservices.

6. The system of claim 1, wherein processing the first part of the request using the group of microservices, and processing the second part of the request using the group of respective remote microservices comprises:
based on determining that the request initiator is the member of the work group, and based on determining that a current target microservice of the request is not owned by a user identity that is part of the work group, forwarding the request to the group of microservices.

7. The system of claim 1, wherein a group of work groups comprises the work group, and wherein determining that the request initiator is the member of the work group comprises:
determining, from the group of work groups, that the request initiator is the member of the work group.

8. The system of claim 1, wherein the request is a first request, wherein the request initiator is a first request initiator, and wherein the operations further comprise:
based on receiving a second request associated with a second request initiator, and based on determining that the second request initiator is not the member of the work group, processing the request using the group of microservices and independently of the group of respective remote microservices.

9. A method, comprising:
receiving, by a system comprising at least one processor, a request to invoke microservices, wherein the request is associated with a request initiator;
determining, by the system, that the request initiator is a member of a work group that identifies respective remote microservices on respective remote computers, wherein the respective remote microservices corresponds to respective microservices of the microservices;
processing, by the system, a first part of the request using the microservices on the system; and
processing, by the system, a second part of the request using the respective remote microservices.

10. The method of claim 9, wherein the work group comprises a first identifier of the work group, a second identifier of a group of user accounts in the work group, and a third identifier of the respective remote microservices.

11. The method of claim 9, further comprising:
based on changing the work group to produce a changed work group, communicating, by the system, the changed work group to a multiplex connection manager of the system that is configured to maintain at least one respective connection with at least one of the respective computers.

12. The method of claim 9, further comprising:
based on changing the work group to produce a changed work group, communicating, by the system, the changed work group to a requests redirection proxy of the system that is configured to intercept and redirect requests that are incoming to a microservice of the microservices or that are outgoing from the microservice.

13. The method of claim 9, further comprising:
based on changing the work group to produce a changed work group, communicating, by the system, the changed work group to a user communication agent of a remote computer of the remote computers, wherein the user communication agent is configured to maintain a communication channel with the system.

14. The method of claim 13, wherein the communicating is performed based on determining that the remote computer is associated with a user account that is the member of the work group.

15. The method of claim 13, wherein the user communication agent is a first user communication agent, wherein the remote computer is a first remote computer, and further comprising:
refraining, by the system, from communicating the changed work group to a second user communication agent of a second remote computer, based on the second remote computer being determined to lack a user account that is the member of the work group.

16. A non-transitory computer-readable medium comprising instructions that, in response to execution, cause a system comprising at least one processor to perform operations, comprising:
receiving a request to invoke microservices, wherein the request is associated with a request initiator;
determining that the request initiator is a member of a work group that identifies respective remote microservices on respective remote computers;
processing a first part of the request using the microservices; and
processing a second part of the request using the respective remote microservices.

17. The non-transitory computer-readable medium of claim 16, wherein a group of work groups comprises the work group, and wherein the system is configured to process respective requests using respective combinations of respective remote microservices of respective groups of the group of work groups and the microservices.

18. The non-transitory computer-readable medium of claim 16, wherein processing the second part of the request using the respective remote microservices comprises invoking a first remote microservice of the respective remote microservices, the first remote microservice invoking a second remote microservice of the respective remote microservices via a peer-to-peer connection.

19. The non-transitory computer-readable medium of claim 16, wherein the microservices and the respective remote microservices comprise a stretched isolated environment for a first user account that is isolated from access by a second user account that has access to the microservices.

20. The non-transitory computer-readable medium of claim 16, wherein processing the second part of the request using the respective remote microservices corresponds to a first load on the system,
wherein invoking a group of microservices of the microservices that is local to the system and that corresponds to the respective remote microservices corresponds to a second load on the system, and
wherein the first load is less than the second load.
